(19) United States
(12) Patent Application Publication
(10) Pub. No.: US 2025/0135305 A1
(43) Pub. Date: May 1, 2025

(54) SUPPORTING AND FASTENING SYSTEM FOR A PORTABLE DEVICE FOR PLAYING GOLF

(71) Applicant: GRAVIT PRACTICE GOLF, S.L., Valencia (ES)

(72) Inventor: Jose Luis Perez Quinonero, Valencia (ES)

(21) Appl. No.: 18/835,467

(22) PCT Filed: Feb. 2, 2023
(86) PCT No.: PCT/ES2023/070055

§ 371 Date: Aug. 2, 2024

(30) Foreign Application Priority Data
Feb. 3, 2022 (ES) U202230168

(51) Int. Cl. A63B 57/40; A63B 69/36

(52) U.S. Cl. CPC A63B 57/40; A63B 69/36

(57) ABSTRACT

The present invention relates to a supporting and fastening system for a portable device for playing golf, consisting of a cylindrical anodised aluminium counterweight (3) measuring 43 mm in diameter and 54 mm in length, weighing 57 g and having a cylindrical hollow (1) performed in a lower base (2) of a counterweight (3), wherein there is a lower threaded rod (4) that is in turn screwed into an internally threaded cylinder (5) fastened on the centre of the lower disc (6) and which protrudes to allow screwing and such that it has a bevelled washer (7) that surrounds the threaded cylinder (5) and that is fastened on the lower disc (6).

The present invention concerns a series of innovative elements that are incorporated into the transportable device for playing or practising golf with application No. 201831621, such as to facilitate its assembly and improve its robustness and stability. The industry sector that the present invention is located in therefore relates to the leisure industry, in particular for playing or practising golf in areas chosen by the user.

### PRIOR ART

The invention is based on the transportable device for playing or practising golf with application No. 201831621, comprising two discs designed with a central orifice that are mounted in parallel position on the upper and lower base of a vertical counterweight and fitted with means to anchor the discs to it, thereby creating a stable assembly in vertical position to hold the balls in the perimeter cavity formed between the discs while preventing, thanks to the counterweight and the immobility of the discs, the device assembly from tipping over due to blows from golf balls. This invention has some drawbacks. For example, there is no fastening element to secure the assembly when screwing the counterweight on the discs. Furthermore, the threaded rod of the counterweight protrudes from the lower side, which may pose a risk due to the sharp elements of the thread or create an inconvenience when placing the assembly on a support base.

The present invention solves the aforementioned drawbacks by providing a serrated washer and a new configuration for the cylinders and threaded rods.

### Explanation of the Invention

In order to achieve the aforementioned design objectives, the invention comprises a cylindrical anodised aluminium counterweight, the lower base of which has a cylindrical recess and a threaded rod that in turn screws into an interior-threaded cylinder protruding from the centre of the lower disc. Furthermore, it has a serrated washer that surrounds the threaded cylinder and is fixed on the lower disc.

This eliminates the protruding lower threaded rod, improving the design and reducing the risk inherent in the protrusion. Furthermore, the serrated washer fastens the counterweight to the lower disc.

The assembly has an upper disc to hold the ball and a mast to secure the upper disc by threading this mast with the upper rod of the counterweight. This achieves the perimeter cavity to house the golf ball. Signage can also be provided on the mast.

Fixed anti-slip silicone studs are provided on the lower disc of the device, acting as a support base to allow the device to adhere to any type of floor or ground.

### SHORT DESCRIPTION OF THE DRAWINGS

In order to complement and help understanding of the characteristics of the invention, a sheet of drawings is attached in which, for illustrative and non-limiting purposes, the following have been represented:

FIG. 1.—Shows an elevation view of the disassembled invention.

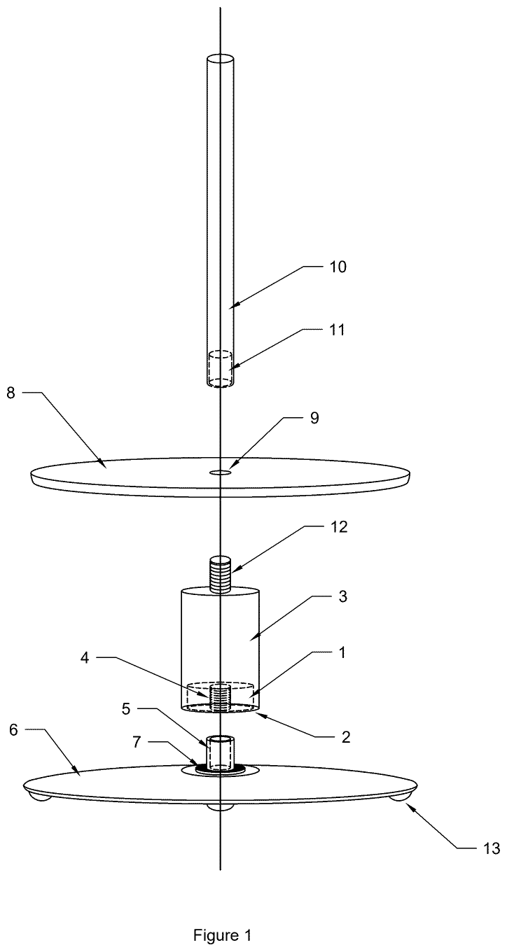

FIG. 2.—Shows an elevation view of the assembled invention.

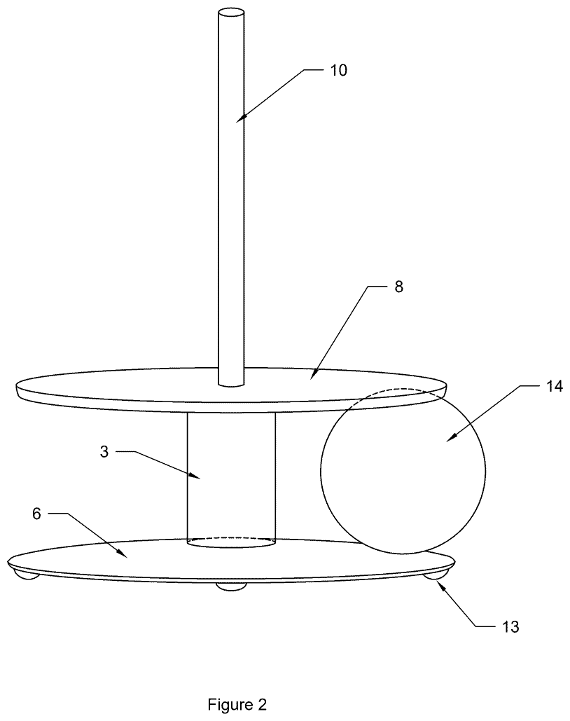

FIG. 3.—Detail of the lower base of the invention.

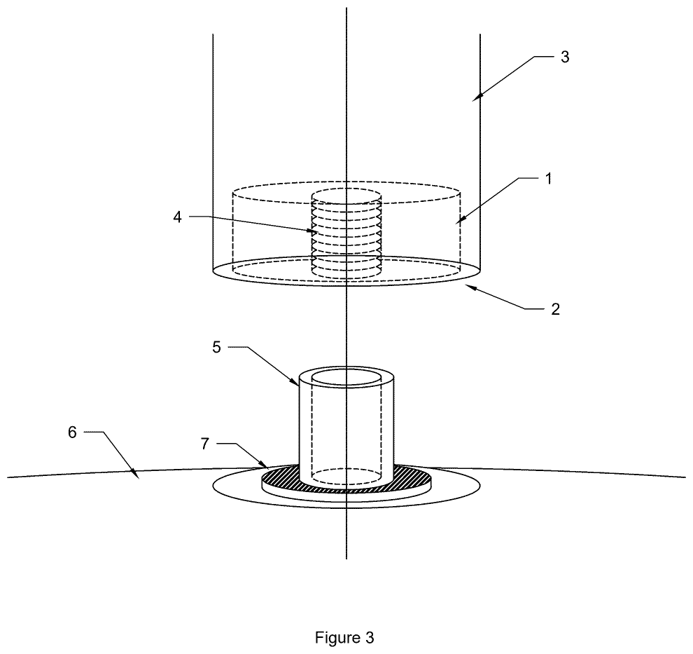

A list of the different elements shown in the figures that make up the invention is provided below.
1=Cylindrical recess in the lower base of the counterweight
2=Lower base of counterweight
3=Counterweight
4=Lower threaded rod
5=Lower disc cylinder with interior thread
6=Lower disc
7=Serrated washer
8=Upper disc
9=Upper disc orifice
10=Mast
11=Mast threading
12=Upper rod and counterweight threading
13=Non-slip silicone pads
14=Golf ball

### Preferred Embodiment of the Invention

The invention comprises a cylindrical anodised aluminium counterweight (3), the lower base (2) of which has a cylindrical recess (1) in which there is a lower threaded rod (4) that screws into an interior-threaded cylinder (5) fastened in the center and protruding from the lower disc (6). Furthermore, it has a serrated washer (7) that surrounds the threaded cylinder (5) and is fixed on the lower disc (6).

The assembly has an upper disc (8) with a central orifice (9) to hold the ball (14) and a mast (10) to secure the upper disc (8) by threading the mast (11) with the upper threaded rod of the counterweight (12). This achieves the perimeter cavity to house the golf ball (14).

Anti-slip silicone studs (13) are fixed on the lower disc (6) of the device, serving as a support base to allow the device to adhere to any type of floor or ground.

1-2. (canceled)

3. A support and fastening system for a portable device for playing golf, said system comprising:
a counterweight (3) having an upper threaded rod (12) provided on an upper surface of said counterweight (3) and a lower threaded rod (4) provided inside a recess (1) in a lower base (2) of said counterweight (3), wherein said lower threaded rod (4) is configured to screw into an internal threaded surface of a cylinder (5) that protrudes from an upper surface of a lower disc (6);
a serrated washer (7) surrounding the cylinder (5);
an upper disc (8) with a orifice (9); and
a mast (10) having a thread (11) configured to receive said upper threaded rod (12) that passes through said orifice (9) so that said upper disc (8) is secured between said mast (10) and said counterweight (3), wherein said counterweight (3) is secured between said upper disc (8) and said lower disc (6) providing a perimeter cavity configured to hold a golf ball (14).

4. The support and fastening system for a portable device for playing golf according to claim 3, wherein said counterweight (5) measures 43 mm in diameter and 54 mm in length.

5. The support and fastening system for a portable device for playing golf according to claim 3, wherein said counterweight (5) weights 57 g.

6. The support and fastening system for a portable device for playing golf according to claim 3, wherein said counterweight (3) is made from anodized aluminum.

7. The support and fastening system for a portable device for playing golf according to claim 3, wherein said cylinder (5) is provided on a center of the upper surface of said lower disc (6).

8. The support and fastening system for a portable device for playing golf according to claim 3, wherein the serrated washer (7) is fixed to the upper surface of said lower disc (6).

9. The support and fastening system for a portable device for playing golf according to claim 3, further comprising anti-slip studs (13) provided on a lower surface of said lower disc (6) configured to secure the device on a surface.

10. The support and fastening system for a portable device for playing golf according to claim 9, wherein said anti-slip studs (13) are made of silicone.

11. The support and fastening system for a portable device for playing golf according to claim 3, wherein said counterweight (3) is cylindrical.

12. The support and fastening system for a portable device for playing golf according to claim 3, wherein said recess (1) is cylindrical.

13. The support and fastening system for a portable device for playing golf according to claim 3, wherein the cylinder (5) is covered by said recess (1) when the lower threaded rod (4) is screwed on the internal threaded surface of said cylinder (5).

14. The support and fastening system for a portable device for playing golf according to claim 3, wherein the orifice (9) of the upper disc (8) is provided on a center of said upper disc (8).
